(19) United States
(12) Patent Application Publication
(10) Pub. No.: US 2017/0011284 A1
(43) Pub. Date: Jan. 12, 2017

(54) PRINTING CONTROL APPARATUS, PRINTING CONTROL PROGRAM, AND PRINTING CONTROL METHOD

(71) Applicant: SEIKO EPSON CORPORATION, Tokyo (JP)

(72) Inventor: Kazuki OHASHI, Shiojiri (JP)

(21) Appl. No.: 15/192,769

(22) Filed: Jun. 24, 2016

(30) Foreign Application Priority Data
Jul. 7, 2015 (JP) 2015-135876

(51) Int. Cl. G06K 15/02; H04N 1/387; H04N 1/393; G06F 3/12

(52) U.S. Cl. CPC G06K 15/1805; G06F 3/1277; G06F 3/1206; G06F 3/1246; H04N 1/3877; H04N 1/393; G06K 15/181

(57) ABSTRACT

A printing control apparatus includes a filter processing portion configured to execute a first filter process of inserting a first description representing a content of processing by a first filter into description data described in a prescribed format for representing an image, and execute a second filter process of inserting a second description representing a content of processing by a second filter into the description data; and a printing data generating portion configured to interpret and convert the description data into printing data. Further, in the first filter process, the filter processing portion inserts the first description into the description data together with identification information associated with the first filter, and in the second filter process, the filter processing portion determines a position of the insertion of the second description within the description data on the basis of the identification information, and inserts the second description at the determined position.

### BACKGROUND

1. Technical Field

The present invention relates to a printing control apparatus, a printing control program, and a printing control method.

2. Related Art

There has been known a printer driver that is configured to generate printing data on the basis of an XML paper specification (XPS) file described in accordance with an XPS specification, and that is further configured to apply a plurality of printing settings to the XPS file by executing pieces of processing by a plurality of filters associated with the respective printing settings on the relevant XPS file (refer to, for example, JP-A-2010-79792). The filters mentioned here are programs each specialized to a specific function, and each of the filters realizes one of various functions, such as a function of rotating an image; a function of enlarging/reducing an image; a function of superimposing a stamp mark on an image; and a Nup function (a function of allocating N pages of images over one medium sheet).

Such a printer driver, which executes pieces of processing by a plurality of filters on an XPS file, applies printing settings to the XPS file efficiently by forming a filter pipeline, that is, a pipeline composed of the plurality of filters, and causing the filter pipeline to sequentially execute the pieces of processing on the XPS file. Meanwhile, there has been known a version 4 printer driver (referred to as a v4 printer driver hereinafter) which is operable under Windows (trade mark) provided by Microsoft (trade mark) and functioning as an operating system (referred to as an OS hereinafter). Microsoft defined a printer driver architecture in relation to the building of such a v4 printer driver, on the basis of which each vender has developed a v4 printer driver product to bring it into widespread use in markets. According to the printer driver architecture, in the filter pipeline, the processing order of the filters which execute pieces of processing on the XPS file is fixedly determined in advance. Such a restriction on the processing order of the filters is likely to cause a case where the effect of processing by an early-processed filter whose processing order is earlier than that of a later-processed filter is not exerted on processing by the later-processed filter. For this reason, a situation where the output result of printing based on printing data to which printing settings are applied through pieces of processing by a plurality of filters associated with the respective printing settings differs from an output result expected by a user has sometimes occurred.

### SUMMARY

An advantage of the invention is that a printing control apparatus, a printing control program, and a printing control method are provided, which make it possible to, when printing based on printing data to which printing settings are applied through pieces of processing by a plurality of filters associated with the respective printing settings is performed, provide a user with a further appropriate printing output result.

According to an aspect of the invention, a printing control apparatus includes a filter processing portion configured to execute a first filter process of inserting a first description representing a content of processing by a first filter into description data described in a prescribed format for representing an image, and execute, after the execution of the first filter process, a second filter process of inserting a second description representing a content of processing by a second filter into the description data; and a printing data generating portion configured to interpret and convert post-processing description data resulting from the execution of the second filter process on the description data, into printing data processable by a printing apparatus. Further, in the first filter process, the filter processing portion inserts the first description into the description data together with identification information associated with the first filter, and in the second filter process, the filter processing portion determines a position of the insertion of the second description within the description data on the basis of the identification information, and inserts the second description at the determined position.

According to this configuration, a position of the insertion of the second description representing the content of processing by the second filter into the description data is determined on the basis of the identification information which is in a state of being inserted together with the first description representing the content of processing by the first filter. In this way, it is possible to exert the effect of processing by the first filter on processing by the second filter whose processing order is later than that of the first filter, thus enabling enhancement of the degree of user's satisfaction with a printing output result. The identification information is, for example, a name given to a canvas element for defining a drawing operation that exerts a function of the first filter.

According to another aspect of the invention, in the above aspect of the invention, the filter processing portion may repeat the execution of the first filter process a plurality of times to insert, for each of a plurality of the first filters having mutually different functions, the first description and the identification information which are associated with the each of the plurality of first filters, into the description data.

According to this configuration, a plurality of positions at each of which the second description may be inserted exists in proportion to the number of the first filters, thus enabling determination an optimum insertion position.

According to another aspect of the invention, in any one of the above aspects of the invention, in the second filter process, the filter processing portion may search for, in accordance with a function of the second filter, identification information serving as the identification information and indicating a position at which the second description is to be inserted, and may insert the second description at a position determined on the basis of the identification information having been searched for.

According to this configuration, it is possible to easily search for and determine an optimum insertion position, in accordance with a function of the second filter. In addition, the filter processing portion may determine the identification information to be searched for, in accordance with which of a function type in which one logical page is handled as a unit of processing and a function type in which one physical page is handled as a unit of processing the function of the second filter belongs to.

According to another aspect of the invention, in any one of the above aspects of the invention, the printing control apparatus may further include a preview display control portion configured to perform control so that a preview display of an image based on the post-processing description data resulting from the execution of the second filter process is performed, and in response to an instruction externally input for instructing a retry of the second filter process as a result of confirmation of the preview display, the filter processing portion may cancel the insertion of the second description by a previous execution of the second filter process, and may insert the second description at a position located within the description data and being different from a position of the insertion of the second description by the previous execution of the second filter process.

According to this configuration, it is possible to allow a user to confirm the preview display, and thereby it is possible to retry the second filter process when needed, thus enabling the user to obtain a desired printing output result with certainty.

The technical thought of the invention can be also realized in categories other than a category of an object such as the printing control apparatus. That is, the invention may be realized in various categories, such as a printing control method, that is, a method including the processes executed by the individual portions of the aforementioned printing control apparatus; a printing control program; that is, a program that causes hardware (a computer) to execute the relevant processes; and a storage medium being readable by a computer and storing the relevant program therein.

### BRIEF DESCRIPTION OF THE DRAWINGS

The invention will be described with reference to the accompanying drawings, wherein like numbers reference like elements.

FIG. 1 is a block diagram illustrating an example of the configuration of a printing control apparatus according to an embodiment of the invention.

FIG. 2 is a flowchart illustrating printing control processing according to an embodiment of the invention.

FIG. 3 is a flowchart illustrating the details of processing in step S140 illustrated in FIG. 2.

FIG. 4 is a diagram illustrating an example of a portion of an XPS file at the time when a first filter process has been executed a plurality of times in printing control processing according to an embodiment of the invention.

FIG. 5 is a diagram illustrating an example of a portion of an XPS file at the time when a second filter process has been executed in printing control processing according to an embodiment of the invention.

FIGS. 6A and 6B are diagrams that describe an example of the effects of an embodiment of the invention.

FIG. 7 is a diagram illustrating another example of a portion of an XPS file at the time when a second file process has been executed in printing control processing according to an embodiment of the invention.

FIG. 8 is a flowchart illustrating printing control processing in a modification example of an embodiment of the invention.

### DESCRIPTION OF EXEMPLARY EMBODIMENTS

Hereinafter, an embodiment of the invention will be described with reference to the drawings.

### 1. Outline of Printing Control Apparatus

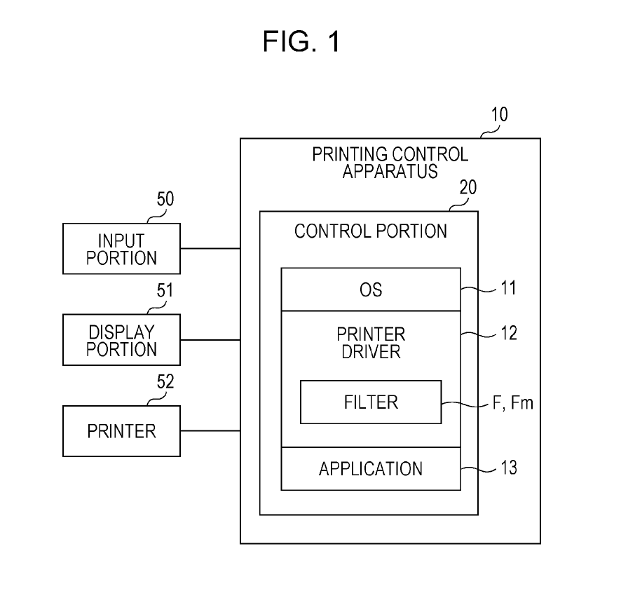

FIG. 1 is a block diagram illustrating an example of the configuration of a printing control apparatus 10 according to this embodiment. This printing control apparatus 10 includes a control portion 20 provided with an IC including components, such as a RAM, a ROM, and a CPU; other storage media; and the like. This control portion 20 is capable of, under an OS 11, executing processes in accordance with programs, such as an application 13 and a printer driver 12, that are recorded in the ROM module and the other storage media. Under an environment controlled by the OS 11, the printer driver 12 (hereinafter, referred to as just a driver 12) which belongs to a type of v4 printer driver is installed. The driver 12 corresponds to an example of a printing control program according to an aspect of the invention. The OS 11 corresponds to an OS under which the v4 printer driver is operable, and Windows 8 can be taken as an example of such an OS.

The printing control apparatus 10 includes an interface (not illustrated), through which, an input portion 50, a display portion 51, and a printer 52 are communicably coupled with the printing control apparatus 10. The input portion 50 is an input device for receiving input operations by a user, and corresponds to a mouse device, a keyboard, a touch panel, various input keys, and/or the like. The display unit 51 is a display for performing display of any image in accordance with a signal output from the control portion 20. The printer 52 is a printing apparatus configured to perform printing of an image represented by printing data output from the control portion 20 on the basis of the printing data; and in this embodiment, the printer 52 performs printing on the basis of printing data resulting from rendering processing by the control portion 20 and output from the control portion 20.

The printing control apparatus 10 is realized by one of various devices capable of serving as a control apparatus for the printer 52, such as a personal computer (PC), a tablet terminal, and a smartphone. Further, a specified portion of components included in the printing control apparatus 10, that is, specified components including at least the control portion 20 among the components included in the printing control apparatus 10, may be recognized as a printing control apparatus according to an aspect of the invention. The printing control apparatus 10, the input portion 50, the display portion 51, and the printer 52 may be individually independent products, or may be a wholly integrated product. For example, each of the printing control apparatus 10, the input portion 50, and the display portion 51 may be made a portion of the printer 52. In this case, the printer 52 may be referred to as a printing control apparatus.

The application 13 is a module for allowing the control portion 20 to realize the function of receiving the contents of input operations performed by using the input portion 50, and thereby creating an image file (for example, an XPS file) capable of containing texts, CGs, pictures, and/or the like, as the elements of the image file itself. The driver 12 is a module for allowing the control portion 20 to realize the function of receiving printing settings performed by using the input portion 50, and the function of executing processes for applying the printing settings. That is, in response to a printing execution command a user has issued on the basis of a result of processing by the application 13, the control portion 20 starts execution of processing by the driver 12 on an XPS file representing a printing target designated by the printing execution command. Such an XPS file corresponds to an example of description data described in a prescribed format for representing an image.

The driver 12 includes a plurality of filters F some of which are used in the processing on the XPS file in a state of being made associated with the respective printing settings. It is determined in accordance with printing setting commands issued by a user which ones of the plurality of filters F are to be used in the processing on the XPS file. In this regard, however, no matter which ones of the filters F are used, the processing order of used filters F is prescribed in advance in the driver 12. That is, in response to the printing setting commands issued by a user, the driver 12 forms a filter pipeline composed of a plurality of filters F that is to be used (to be made valid) at this time point, and then uses this filter pipeline in the processing on the XPS file. In this meaning, a specified portion of the function of the driver 12 may be referred to as a filter pipeline manager or the like.

### 2. Description of Printing Control Processing

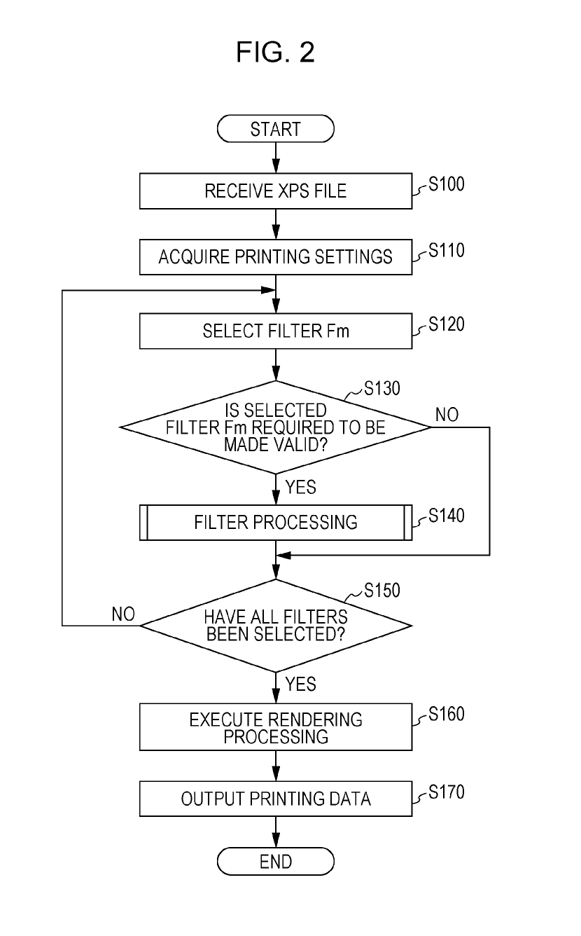

FIG. 2 illustrates a flowchart of printing control processing (a printing control method) realized by causing the control portion 20 to execute the driver 12, that is, by causing the control portion 20 and the driver 12 to cooperate with each other. This flowchart starts at a timing point when, in a state in which an XPS file representing a printing target is already generated by the application 13, a user has input a printing execution command for instructing the execution of printing of the printing target, by operating the input portion 50.

The driver 12 receives the XPS file representing a printing target, from the application 13 (step S100), and further, acquires the contents of printing settings (step S110). An image represented by the XPS file received in step S100 will be also referred to as an original image hereinafter. The contents of the printing settings acquired in step S110 are the contents of printing settings a user has input by operating the input portion 50 before inputting the printing execution command. For example, in the course before the receipt of the input of the printing execution command, the driver 12 prompts the user to input printing settings by displaying a prescribed user interface (UI) screen for receiving the inputs of the printing settings. In this way, the driver 12 can acquire the contents of the printing settings having been input through the user's operations on the UI screen.

Next, the driver 12 selects a filter F whose pre-prescribed processing order is the earliest at this time point among the plurality of filters F (step S120), and determines whether or not the selected filter F is to be made valid in the filter pipeline, on the basis of the contents of the printing settings having been acquired in step S110 (step S130). Here, for the sake of convenience, the filters F are also denoted by filters Fm (refer to FIG. 1). The number m is any one of natural numbers 1 to M, M being larger than “1”, and the smaller the number m of a filter Fm is, the earlier the processing order of the filter Fm is. In step S120 to which the process flow proceeds first, that is, subsequently to step S110, the driver 12 absolutely selects a filter F1. In step S120 to which the process flow proceeds thereafter, a filter Fm whose number m is the smallest at this time point among one or more unselected filters Fm is selected. In step S130, in the case where the selected filter Fm (i.e., the filter Fm having been selected in step S120 immediately before currently described step S130) is a filter having a function that realizes any one of the printing settings having been acquired in step S110, the driver 12 determines that the selected filter Fm is to be made valid (“Yes” in step S130), and then causes the process flow to proceed to step S140.

As a specific example, it is assumed that, in step S110, the driver 12 has acquired the contents of printing settings: rotating an image; enlarging/reducing an image; mirror-reversing an image; and superimposing a specific stamp mark. The plurality of filters Fm includes various types of filters Fm, such as a rotating function filter for rotating an image by 90 degrees; an enlarging/reducing function filter for enlarging/reducing an image; a reversing function filter for mirror-reversing an image; and a stamp-mark superimposing function filter for vertically superimposing a specific stamp mark. In addition, the specific stamp mark is, for example, a mark or a string of characters for informing users of a notice, such as “confidential”, “internal use only” or “copy inhibit”. When describing using such a specific example, in step S130, in the case where the selected filter Fm corresponds to any one of the rotating function filter; the enlarging/reducing function filter; the reversing function filter; and the stamp-mark superimposing function filter, the driver 12 determines that the selected filter Fm is to be made valid. In contrast, in the case where the selected filter Fm does not correspond to any one of the rotating function filter; the enlarging/reducing function filter; the reversing function filter; and the stamp-mark superimposing function filter, the driver 12 determines that the selected filter Fm is to be made invalid (“No” in step S130). In the case where, in step S130, it has been determined that the selected filter Fm is to be made invalid, the driver 12 cause the process flow to proceed, not to step S140, but to step S150.

In step S140, the driver 12 executes a process on the received XPS file with respect to the filter Fm having been determined to be made valid in step S130. That is, the driver 12 executes a filter process of inserting a description representing the content of processing by the filter Fm having been determined to be made valid in step S130, into the received XPS file (description data).

In step S150, the driver 12 determines whether or not a filter Fm having the last processing order (i.e., a filter FM) has been selected in step S120, and in the case where the filter FM has not yet been selected (“No” in step S150), the driver 12 causes the process flow to return to step S120 and repeats the processes in step S120 and steps subsequent thereto. In contrast, in the case where the filter FM has already been selected in step S120, (“Yes” in step S150), the driver 12 causes the process flow to proceed to step S160.

When describing using the specific example, at the time when the determination “Yes” has been made in step S150, as a result, the filter processes with respect to the respective four filters Fm, that is, the rotating function filter; the enlarging/reducing function filter; the reversing function filter; and the stamp-mark superimposing function filter, have been executed on the received XPS file. It is assumed, here, that the filter processes (each being a process of inserting a description representing the content of processing by a corresponding one of the four filters Fm) have been executed on the received XPS file in order as follows: the rotating function filter; the enlarging/reducing function filter; the reversing function filter; and the stamp-mark superimposing function filter.

In this embodiment, with respect to the rotating function filter; the enlarging/reducing function filter; the reversing function filter; and the stamp-mark superimposing function filter, which are the filters having been taken in the specific example, each of the rotating function filter; the enlarging/reducing function filter; and the reversing function filter is also referred to as a first filter, and the stamp-mark superimposing function filter is also referred to as a second filter. The second filter is basically a filter having the function of adding an additional image or superimposing a string of characters, onto the original image represented by the received XPS file. The second filter includes, in addition to the stamp-mark superimposing function filter, a header/footer adding filter for adding a header/footer onto a top space/bottom space of a page; a watermark superimposing function filter for superimposing a specific watermark image on an image; and the like. Meanwhile, the first filter is a filter not corresponding to the second filter, and corresponds to not only each of the rotating function filter; the enlarging/reducing function filter; and the reversing function filter, but also a Nup function filter for realizing the Nup function, or the like.

According to the processing order of the filters Fm, which is prescribed in the driver 12, the processing order of the second filter is later than that of each of the first filters. Further, in this embodiment, a filter process executed in step S140 for inserting a first description, that is, a description representing the content of processing by the first filter, into the received XPS file is referred to as a first filter process; and a filter process executed in step S140 for inserting a second description, that is, a description representing the content of processing by the second filter, into the received XPS file is referred to as a second filter process. That is, the second filter process is executed after the executions of the first filter processes. In the respect that the control portion 20 realizes such filter processes in step S140, it can be said that the control portion 20 functions as a filter processing portion.

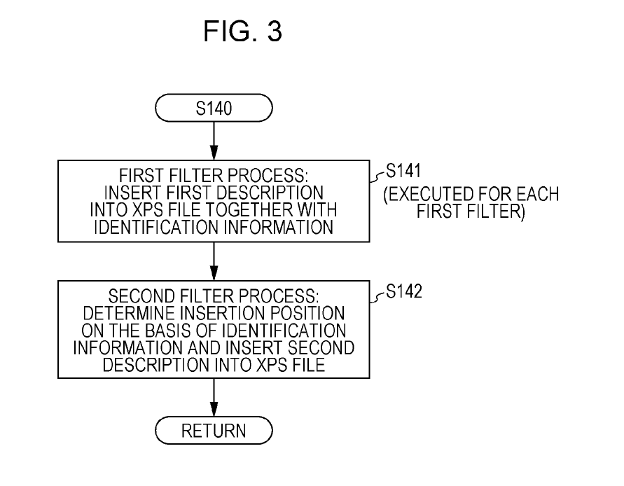

The first filter process and the second filter process in step S140 will be each described below in more detail by using FIGS. 3 to 5.

FIG. 3 is a flowchart illustrating the details of each of the first process and the second process in step S140. The specific example will be also used in the following description using FIGS. 3 to 5. In step S141 (i.e., in the first filter process), the driver 12 inserts a first description representing the content of processing by a given first filter, together with identification information associated with the relevant first filter, into the received XPS file. Specific examples of the first filter mentioned here are the aforementioned three filters: the rotating function filter; the enlarging/reducing function filter; and the reversing function filter, and the driver 12 repeats, for each of these three filters, the first filter process, in accordance with the aforementioned processing order of these three filters. That is, the driver 12 repeats the process in step S141 a plurality of times equivalent to the number of the first filters having been made valid. That is, when assuming the specific example, through the plurality of repetitions of the first filter process, the driver 12 inserts, for each of the plurality of first filters having mutually different functions, the first description and the identification information which are associated with the relevant first filter, into the received XPS file.

Next, in step S142 (i.e., in the second filter process), the driver 12 determines a position which is located within the received XPS file and at which a second description representing the content of processing by a given second filter is to be inserted, and then inserts the second description at the determined portion. A specific example of the second filter mentioned here is the aforementioned stamp-mark superimposing function filter.

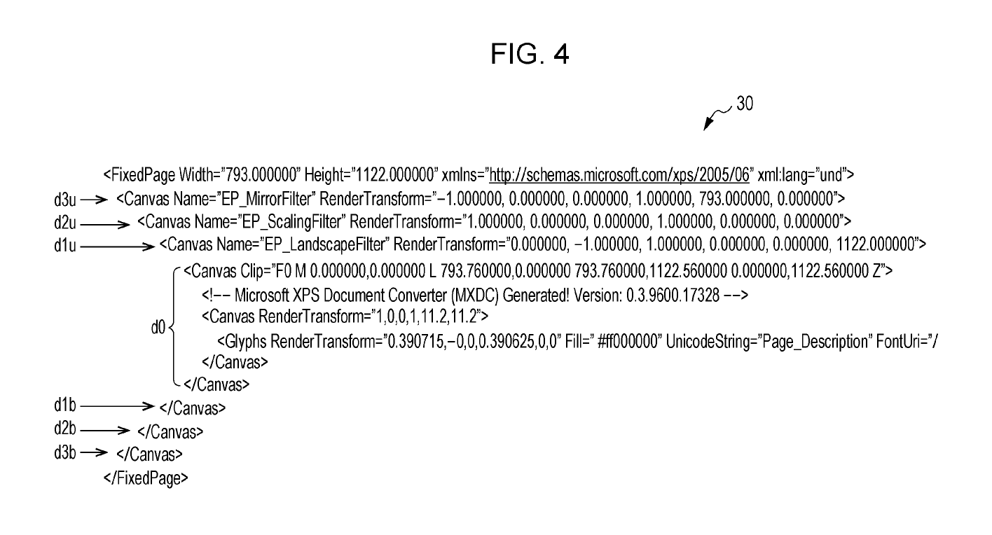

FIG. 4 illustrates an example of a portion of the XPS file 30 at the time when the first filter process in step S141 has been executed a plurality of times. In FIG. 4, a region denoted by a sign d0 (i.e., a description region d0) in descriptions contained in the XPS file 30 is a portion of descriptions contained in the received XPS file, and corresponds to one page of the original image represented by the received XPS file.

A pair of descriptions d1u and d1b each inserted at a corresponding one of positions sandwiching the description region d0 from above and below is an example of a first description representing the content of processing by the rotating function filter whose processing order is the earliest in the specific example. These descriptions d1u and d1b include “Canvas” and “/Canvas”, respectively, which are canvas elements for defining a drawing operation that exerts the function of a corresponding filter. Such canvas elements are elements, defined in the XPS specification, for performing a drawing operation in a lump. Through the insertion of the descriptions d1u and d1b using such canvas elements at positions above and below the description region d0, the effect of a rotation operation by the rotating function filter is exerted on the whole of a drawn image represented by the description region d0. Further, the description d1u contains a description: Name=“EP_LandscapeFilter”. This Name=“EP_LandscapeFilter” is a name (a name attribute of a canvas element) given to the pair of canvas elements for defining a drawing operation that exerts the function of the rotating function filter. Such a name is an example of identification information that is associated with the first filter (the rotating function filter).

Similarly, a pair of descriptions d2u and d2b each inserted at a corresponding one of positions sandwiching a region between the descriptions d1u and d1b from above and below is an example of a first description representing the content of processing by the enlarging/reducing function filter whose processing order is subsequent to that of the rotating function filter in the specific example. Similarly, these descriptions d2u and d2b include “Canvas” and “/Canvas”, respectively, which are canvas elements. Through the insertion of the descriptions d2u and d2b using such canvas elements at positions above and below the region between the descriptions d1u and d1b, the effect of an enlarging/reducing operation by the enlarging/reducing function filter is exerted on the whole of a region on which the effect of the rotating operation by the rotating function filter is exerted. Further, the description d2u contains a description: Name=“EP_ScalingFilter”. This Name=“EP_ScalingFilter” is a name (a name attribute of a canvas element) given to the pair of canvas elements for defining a drawing operation that exerts the function of the enlarging/reducing function filter. Such a name is an example of identification information that is associated with the first filter (the enlarging/reducing function filter).

Similarly, a pair of descriptions d3u and d3b each inserted at a corresponding one of positions sandwiching a region between the descriptions d2u and d2b from above and below is an example of a first description representing the content of processing by a reversing function filter whose processing order is subsequent to that of the enlarging/reducing function filter in the specific example. Similarly, these descriptions d3u and d3b include “Canvas” and “/Canvas”, respectively, which are canvas elements. Through the insertion of the descriptions d3u and d3b using such canvas elements at positions above and below the region between the descriptions d2u and d2b, the effect of a reversing operation by the reversing function filter is exerted on the whole of a region on which the effect of the enlarging/reducing operation by the enlarging/reducing function filter is exerted. Further, the description d3u contains a description: Name=“EP_MirrorFilter”. This Name=“EP_MirrorFilter” is a name (a name attribute of a canvas element) given to the pair of canvas elements for defining a drawing operation that exerts the function of the reversing function filter. Such a name is an example of identification information that is associated with a first filter (a reversing function filter).

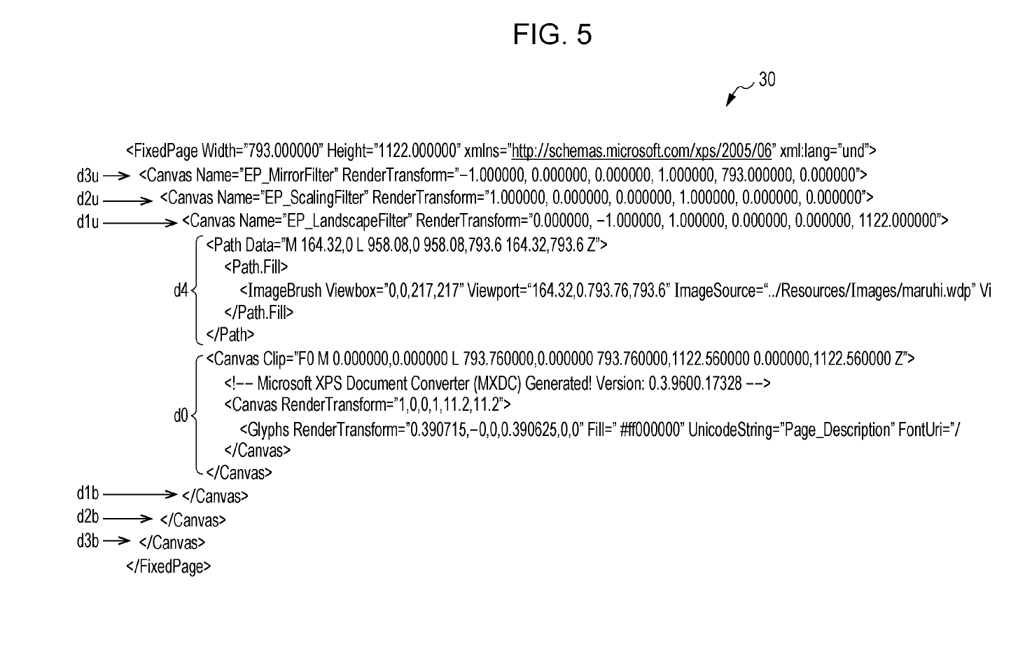

FIG. 5 illustrates an example of a portion of the XPS file 30 at the time when the second filter process in step S142 has been executed. As understood by comparing FIG. 5 with FIG. 4, a region denoted by a sign d4 (i.e., a description region d4) is further added.

Specifically, in step S142, the driver 12 convers the structure of the whole of the descriptions of the XPS file 30 into a document object model (DOM) tree structure, and searches for desired identification information (i.e., a desired one of the name attributes described above) by using a SelectSingleNode function and an XPath. The SelectSingleNode function is a function for searching for a DOM tree node; and the XPath is a character string representing conditions for the relevant search.

In this embodiment, the driver 12 determines a name attribute to be searched for in accordance with the function of a second filter, on the basis of a pre-prescribed policy. In the case where this second filter is the stamp-mark superimposing function filter just like in the specific example, the driver 12 determines a name attribute associated with the rotating function filter whose processing order is the earliest, as the name attribute to be searched for. Further, the driver 12 searches for the name attribute associated with the rotating function filter (i.e., the “EP_LandscapeFilter”). In other words, the driver 12 searches for a canvas node containing the name attribute “EP_LandscapeFilter”. As a result of this search, the driver 12 determines a position located immediately after the searched-for canvas node containing the name attribute “EP_LandscapeFilter” (i.e., a position located between the description d1u and the description region d0) as a position at which the description region d4, that is, a second description representing the content of processing by the stamp-mark superimposing function filter, is to be inserted, and then inserts the description region d4 at the determined position. This insertion of the description position d4 at such a position makes it possible to exert the effect of the rotating operation by the rotating function filter on the whole of an image resulting from vertically superimposing a specific stamp mark on the drawn image represented by the description region d0, and further exert the effect of the enlarging/reducing operation by the enlarging/reducing function filter on the whole of an image resulting from the rotating operation. Moreover, the insertion of the description position d4 at such a position also makes it possible to exert the effect of a mirror-reversing operation by the reversing function filter on the whole of an image resulting from the enlarging/reducing operation.

Let us return to the description using FIG. 2. In step S160, the driver 12 executes rendering processing by applying a prescribed rendering filter to the XPS file (the XPS file 30) having been subjected to the first filter processes and the second filter process. Through the execution of the rendering processing, the driver 12 interprets current data based on an XML format; executes a conversion to bit-map data; color conversion processing; halftone processing; rearrangement processing; and the like; and thereby generates printing data executable in printing processing by the printer 52. In the respect that the control portion 20 realizes such a process in step S160, it can be said that the control portion 20 functions as a printing data generating portion. Further, the driver 12 outputs the printing data resulting from the rendering processing to the printer 52 (step S170). In response to receipt of the printing data, the printer 52 executes printing based on the printing data.

### 3. Effect and Additional Description of this Embodiment

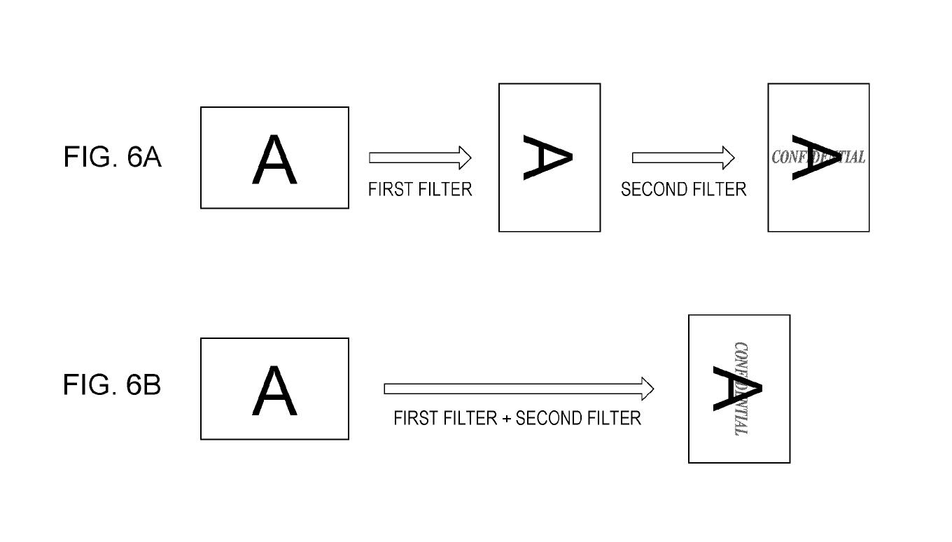

FIGS. 6A and 6B are diagrams that describe an example of the effect of this embodiment. FIG. 6A illustrates an example of an existing case in which the aforementioned technology of this embodiment is not applied to an XPS file having been optionally designated by a user; and FIG. 6B illustrates an example of a case in which the aforementioned technology of this embodiment is applied to the XPS file. The XPS file represents a certain original image (an image having a character “A” on its substantially central position in each of the examples illustrated in FIGS. 6A and 6B). In FIGS. 6A and 6B, for the sake of the simplicity of description below, it is assumed that, after a user has optionally input printing settings, the rotating function filter and the stamp-mark superimposing function filter have been made valid as the first filter and the second filter, respectively, and thereafter, the filter processes on the relevant XPS file with respect to the first filter and the second filter have been executed. Under such an assumption, in the example of the existing case in which the technology of this embodiment is not applied, processing for executing a process of inserting a first description representing the content of processing by the rotating function filter into the XPS file and thereafter executing a process of inserting a second description representing the content of processing by the stamp-mark superimposing function filter into the XPS file is merely performed. Thus, in the example of the existing case, after the execution of the rendering processing, a printing result being in a state in which a specific stamp mark (a so-called “CONFIDENTIAL” mark illustrated in each of FIGS. 6A and 6B) is vertically superimposed on an image resulting from rotating the original image by 90 degrees from its original direction, that is, on an image whose top-bottom direction is directed in a horizontal direction, is obtained (FIG. 6A). That is, as a result, a printing result in which the top-bottom direction of an image represented by the XPS file and the top-bottom direction of the stamp mark are different from each other is obtained. Unfortunately, it cannot be said that this printing result is a result expected by a user.

Meanwhile, in the case where the technology of this embodiment is applied, when the filter process with respect to a second filter (for example, the stamp-mark superimposing function filter) whose order of processing on the XPS file is later than that of a first filter (for example, the rotating function filer) is executed, a position at which a second description representing the content of processing by the second filter is to be inserted is determined on the basis of identification information that is inserted so as to be associated with a first description representing the content of processing by the first filter and having been inserted earlier than the second description. Thus, it is possible to insert the second description representing the content of processing by the second filter at a position that is located within the XPS file and that makes it possible to exert the effect of the processing by the first filter on the processing by the second filter whose filter-process order is later than that of the first filter. In this way, under the constraint that the processing order of the filters Fm is not allowed to be changed, as illustrated in the example in FIG. 6B, it is possible to, after the execution of the rendering processing, obtain a printing result being in a state in which, on an image resulting from rotating an original image by 90 degrees from its original direction (i.e., on an image whose top-bottom direction is directed in a horizontal direction), a specific stamp mark having been subjected to the effect of the relevant rotating operation similarly to the original image, and thereby being in a state in which the top-bottom direction of the specific stamp mark itself is directed in the horizontal direction is superimposed; thereby making it possible to satisfy the user's expectation on the printing result.

As described above, for each first process associated with a corresponding one of a plurality of first filters having been made valid, one of pieces of mutually different identification information (name attributes) each associated with a corresponding one of the plurality of first filters is inserted into the XPS file (refer to step S141 in FIG. 3, and FIG. 4), and thus, as a result, there exists a plurality of positions at each of which a second description representing the content of processing by a second filter may be inserted. In step S142 (i.e., in the second filter process), the driver 12 searches for identification information (a name attribute) indicating a position at which the second description is to be inserted, in accordance with the function of the second filter, and then inserts the second description at a position having been determined on the basis of the searched-for identification information. As described above, the driver 12 determines the name attribute to be searched for in accordance with the function of the second filter, on the basis of a pre-prescribed policy. In the case where the second filter is the stamp-mark superimposing function filter just like in the specific example, the driver 12 determines the name attribute “EP_LandscapeFilter”, which is associated with the first filter (the rotating function filter) whose processing order is the earliest among the first filters, as the name attribute to be searched for, on the basis of a policy stating that the effects of operations by the respective first filters, that is, the effects of the rotating operation, the enlarging/reducing operation, and the mirror-reversing operation, are to be exerted on the direction and the size of a stamp mark to be superimposed.

In addition, if the driver 12 determines a position at which the description region d4, that is, the second description representing the content of processing by the stamp-mark superimposing function filter, is to be inserted, on the basis of the name attribute “EP_ScalingFilter” associated with the enlarging/reducing function filter, the driver 12 inserts the description region d4 at a position located immediately after a canvas node containing the relevant name attribute “EP_ScalingFilter” (i.e., at a position located between the description d2u and the description d1u). In this way, it possible to exert the effects of the enlarging/reducing operation by the enlarging/reducing function filter and the mirror-reversing operation by the reversing function filter on the whole of an image resulting from vertically superimposing a specific stamp mark on an image resulting from rotating the drawn image represented by the description region d0 by 90 degrees. Further, if the driver 12 determines a position at which the description region d4, that is, the second description representing the content of processing by the stamp-mark superimposing function filter, is to be inserted, on the basis of the name attribute “EP_MirrorFilter” associated with the reversing function filter, the driver 12 inserts the description region d4 at a position located immediately after a canvas node containing the relevant name attribute “EP_MirrorFilter” (i.e., at a position located between the description d3u and the description d2u). In this way, it possible to exert the effect of the mirror-reversing operation by the reversing function filter on the whole of an image resulting from vertically superimposing a specific stamp mark on an image resulting from enlarging/reducing the image resulting from rotating the drawn image represented by the description region d0 by 90 degrees.

Moreover, for example, in the case where the second filter is the watermark superimposing function filter, the driver 12 may determine the name attribute associated with the reversing function filter, as the name attribute to be searched for, on the basis a policy stating that the effects of the rotating operation and the enlarging/reducing operation are not to be exerted on a watermark image to be superimposed. In this way, it is possible to exert the effect of the mirror-reversing operation by the reversing function filter on the whole of an image resulting from superimposing a watermark image on the image resulting from enlarging/reducing the image resulting from rotating the drawn image represented by the description region d0 by 90 degrees.

Further, in step S142 (i.e., in the second filter process) the driver 12 may determine identification information (a name attribute) to be searched for, in accordance with which of a function type in which one logical page is handled as a unit of processing and a function type in which one physical page is handled as unit of processing the function of the second filter belongs to. The function type in which one logical page is handled as a unit of processing unit is a function type to which functions each being preferable to be applied for each logical page defined by an XPS file belong, and the stamp-mark superimposing function is a representative example of such functions. Meanwhile, the function type in which one physical page is handled as a unit of processing is a function type to which functions each being preferable to be applied for each physical page (each sheet of paper) belong, and a header/footer adding function is a representative example of such functions. Further, the driver 12 may have a policy (a policy relating to a logical/physical page) stating that, when the function of a second filter belongs to the function type in which one logical page is handled as a unit of processing, identification information (a name attribute) to be searched for is to be determined from any one of a plurality of pieces of identification information each associated with a corresponding one of first filters; while, when the function of the relevant second filter belongs to the function type in which one physical page is handled as a unit of processing, any of the plurality of pieces of identification information each associated with a corresponding one of the first filters is not to be searched for.

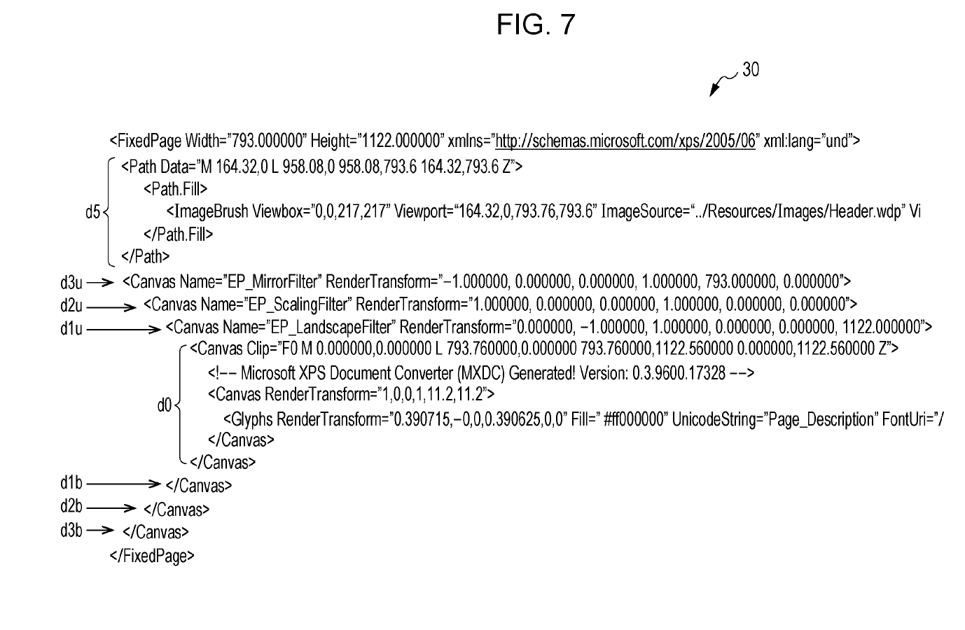

FIG. 7 illustrates an example of a portion of the XPS file 30 at the time when the process in step S142 (the second file process) has been executed, and this example is different from the example illustrated in FIG. 5. As understood by comparing FIG. 7 with FIG. 4, in FIG. 7, as a result of the execution of the process in step S142, a region denoted by a sign d5 (i.e., a description region d5) is further added. Further, as understood by comparing FIG. 7 with FIG. 5, in FIG. 7, the description region d5 is inserted, but the description region d4 does not exist; while in contrast, in FIG. 5, the description region d4 is inserted, but the description region d5 does not exist. Such FIG. 7 illustrates a result obtained by allowing the driver 12 to make a header/footer adding function filter valid as a second filter and execute the process in step S142 on the basis of the policy relating to a logical/physical page. When based on the policy relating to a logical/physical page, in the case where the second filter is the header/footer adding function filter, the driver 12 does not search for any of the plurality of pieces of identification information (the name attributes) each associated with a corresponding one of the first filters, and inserts the description region d5, that is, a second description representing the content of processing by the header/footer adding function filter, at a regular description position. The regular description position mentioned here is, as illustrated in FIG. 7, a position located immediately above a description having been inserted in an immediately previously executed filter process (i.e., a position located immediately above the description d3u, which is the first description representing the content of processing by the reversing function filter). Through the insertion of the description region d5 at such a position, it is possible to obtain a printing result in which, regardless of the effect of the rotating operation by the rotating function filter, the effect of the enlarging/reducing operation by the enlarging/reducing function filter, and the effect of the mirror-reversing operation by the reversing function filter, a header/footer is added onto the top space/bottom space of a page (a physical page).

In the case where the Nup function filter is included in first filters having been made valid, a preferred result is also likely to be obtained by employing the policy relating to a logical/physical page. When, for example, after the executions of first filter processes including a first filter process with respect to the Nup function filter, executing a second filter process with respect to the stamp-mark superimposing function filter functioning as a second filter, as described above, the driver 12 searches for identification information (a name attribute) associated with a first filter whose processing order is the earliest among the first filters on the basis of the relevant policy, and inserts a second description with respect to the stamp-mark superimposing function filter at a position located within the XPS file and being in accordance with a result of the search. In this way, it is possible to obtain a preferable printing result in which a specific stamp mark is superimposed on each of N pages (for example, two pages) of logical pages that are allocated on one sheet of paper (one physical page). Meanwhile, when, for example, after the executions of first filter processes including a first filter process with respect to the Nup function filter, executing a second filter process with respect to the header/footer adding function filter functioning as a second filter, the driver 12 does not search for any of a plurality of pieces of identification information each associated with a corresponding one of the first filters on the basis of the relevant policy, and inserts a second description with respect to the Nup function filter at the regular description position within the XPS file. In this way, it is possible to obtain a preferable printing result in which a header/footer is added on the top space/bottom space of one sheet of paper on which N pages (for example, two pages) of logical pages are allocated.

### 4. Modification Example

The invention is not limited to the aforementioned embodiment, but can be practiced in various embodiments within the scope not departing from the gist of the invention, and such a modification example as described below may be employed as an example of such embodiments. It is to be noted that the scope of the disclosure of the invention also includes any configuration resulting from appropriately combining any modification example with the aforementioned embodiment.

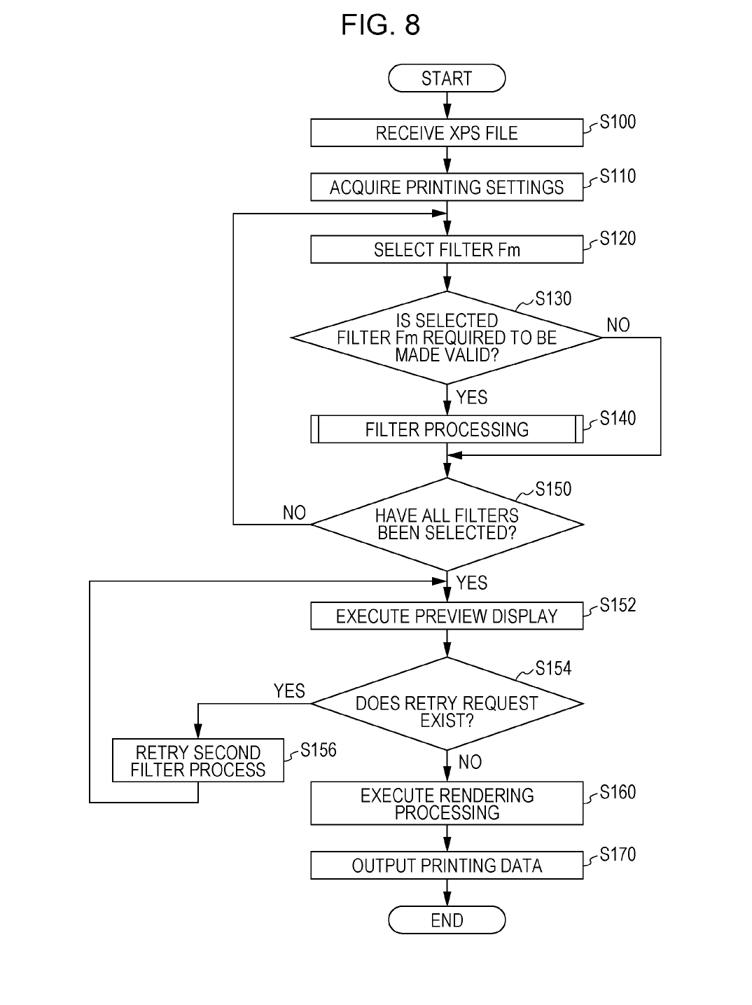

FIG. 8 illustrates a flowchart of another printing control processing (another printing control method) realized by causing the control portion 20 to execute the driver 12, that is, by causing the control portion 20 and the driver 12 to cooperate with each other, and this flowchart is different from the flowchart illustrated in FIG. 2. As compared with the flowchart illustrated in FIG. 2, the flowchart illustrated in FIG. 8 is different therefrom in the respect that it includes steps S152, S154, and S156.

In step S152, the driver 12 performs a preview display on the display portion 51 with respect to an image based on an XPS file (an XPS file 30) having been subjected to the first filter processes and the second filter process. That is, the driver 12 interprets the content of an XPS file 30 which is obtained at the time when the determination “Yes” has been made in step S150; generates image data, in a prescribed format, for performing display on the display portion 51; and causes the display portion 51 to execute display processing based on the generated image data. This preview display enables a user to confirm an image being in a state in which the first filter processes and the second filter process are already performed on the original image, that is, an image at a time point immediately before the execution of printing. In the respect that the control portion 20 realizes such a process in step S152, it can be said that the control portion 20 functions as a preview display control portion.

While viewing the preview display, the user can notify the control portion 20 of whether or not the result of the preview is acceptable, by operating the input portion 50. Upon recognition, via the input portion 50, of receipt of a notification notifying that the result of the preview is acceptable, the driver 12 determines that any retry request does not exist (“No” in step S154), and causes the process flow to proceed to step S160. In contrast, upon recognition, via the input portion 50, of receipt of a notification notifying that the result of the preview is unacceptable, the driver 12 determines that a retry request exists (“Yes” in step S154), and causes the process flow to proceed to step S156.

In the case where the retry request exists, the driver 12 retries the second filter process (step S156). The retry of the second filter process is a process of canceling the insertion of a second description in the second filter process having already been executed in step S142 (refer to FIG. 3) and further inserting the second description at a position located within the XPS file 30 and being different from a position at which the second description has been inserted in the second filter process having already been executed. The cancel of the insertion of a second description in the second filter process having already been executed in step S142 means the deletion of the second description (for example, the description region d4 illustrated in FIG. 5) having been inserted into the XPS file 30 in step S142. Subsequently to the deletion, the driver 12 inserts the relevant second description having been deleted, at a different position. For example, it is assumed that a position at which a second description has been inserted in the second filter process in step S142 is a position having been determined as a result of searching for the name attribute “EP_LandscapeFilter” associated with the rotating function filter (i.e., a position located immediately after the canvas node containing the name attribute “EP_LandscapeFilter”). In this case, the different position corresponds to a position that is determined as a result of searching for the name attribute “EP_ScalingFilter” associated with the enlarging/reducing filter (i.e., a position located immediately after the canvas node containing the name attribute “EP_ScalingFilter”); a position that is determined as a result of searching for the name attribute “EP_MirrorFilter” associated with the rotating function filter (i.e., a position located immediately after the canvas node containing the name attribute “EP_MirrorFilter”; or the regular description position.

When inserting the second description at a different position by employing any one of such a plurality of options for the different position, the driver 12 may determine the different position in accordance with a user's instruction, or automatically without requesting an instruction from a user (i.e., on the basis of a prescribed criterion, or at random). As a result of such a retry of the second filter process, an XPS file 30 containing the second description having been inserted at the different position is generated. Subsequently, the driver 12 causes the process flow to return to step S152, and causes the display portion 51 to perform a preview display operation based on the XPS file 30 in which the result of the latest retry is reflected. According to this modification example, a user can retry the second filter process while confirming the preview display, and thus, the user can easily obtain a truly desired printing result. In addition, in this modification example, an alternative process flow in which, subsequent to the execution of the preview display process in step S152, the driver 12 causes the process flow to return to step S110; allows a user to perform printing settings again, and then, executes the processes in steps subsequent to step S110 again may be employed.

The entire disclosure of Japanese Patent Application No. 2015-135876, filed Jul. 7, 2015 is expressly incorporated by reference herein.

What is claimed is:

1. A printing control apparatus comprising:
a filter processing portion that executes a first filter process of inserting a first description representing a content of processing by a first filter into description data described in a prescribed format for representing an image, and execute, after the execution of the first filter process, a second filter process of inserting a second description representing a content of processing by a second filter into the description data; and
a printing data generating portion that interprets and converts post-processing description data resulting from the execution of the second filter process on the description data, into printing data processable by a printing apparatus,
wherein, in the first filter process, the filter processing portion inserts the first description into the description data together with identification associated with the first filter, and in the second filter process, the filter processing portion determines a position of the insertion of the second description within the description data on the basis of the identification information, and inserts the second description at the determined position.

2. The printing control apparatus according to claim 1, wherein the filter processing portion repeats the execution of the first filter process a plurality of times to insert, for each of a plurality of the first filters having mutually different functions, the first description and the identification information which are associated with the each of the plurality of first filters, into the description data.

3. The printing control apparatus according to claim 1, wherein, in the second filter process, the filter processing portion searches for, in accordance with a function of the second filter, identification information serving as the identification information and indicating a position at which the second description is to be inserted, and inserts the second description at a position determined on the basis of the identification information having been searched for.

4. The printing control apparatus according to claim 3, wherein the filter processing portion determines the identification information to be searched for, in accordance with which of a function type in which one logical page is handled as a unit of processing and a function type in which one physical page is handled as a unit of processing the function of the second filter belongs to.

5. The printing control apparatus according to claim 1, wherein the identification information is a name given to a canvas element that defines a drawing operation for exerting a function of the first filter.

6. The printing control apparatus according to claim 1, further comprising:
a preview display control portion that performs control so that a preview display of an image based on the post-processing description data resulting from the execution of the second filter process on the description data is performed,
wherein, in response to an instruction externally input for instructing a retry of the second filter process as a result of confirmation of the preview display, the filter processing portion cancels the insertion of the second description by a previous execution of the second filter process, and inserts the second description at a position located within the description data and being different from a position of the insertion of the second description by the previous execution of the second filter process.

7. A computer-readable recording medium storing a printing control program that causes a computer to execute processing comprising:
a first filter process of inserting a first description representing a content of processing by a first filter into description data described in a prescribed format for representing an image;
a second filter process of inserting a second description representing a content of processing by a second filter into the description data after the execution of the first filter process; and
a printing data generating process of interpreting and converting post-processing description data resulting from the execution of the second filter process on the description data into printing data processable by a printing apparatus,
wherein, in the first filter process, the first description is inserted into the description data together with identification information associated with the first filter, and in the second filter process, a position of the insertion of the second description within the description data is determined on the basis of the identification information and the second description is inserted at the determined position.

8. A printing control method comprising:
performing filter processing for executing a first filter process of inserting a first description representing a content of processing by a first filter into description data described in a prescribed format for representing an image, and a second filter process of inserting a second description representing a content of processing by a second filter into the description data after the execution of the first filter process; and
performing printing data generating processing for interpreting and converting post-processing description data resulting from the execution of the second filter process on the description data into printing data processable by a printing apparatus,
wherein, in the first filter process, the first description is inserted into the description data together with identification information associated with the first filter, and in the second filter process, a position of the insertion of the second description within the description data is determined on the basis of the identification information and the second description is inserted at the determined position.
